(19) United States
(12) Patent Application Publication
(10) Pub. No.: US 2010/0024846 A1
(43) Pub. Date: Feb. 4, 2010

(54) Detergents

(75) Inventors: Nadine Warkotsch, Duesseldorf (DE); Johannes Zipfel, Duesseldorf (DE); Christian Nitsch, Duesseldorf (DE); Arnd Kessler, Monheim (DE); Thomas Holderbaum, Hilden (DE); Cornelius Bessler, Duesseldorf (DE); Susanne Tondra, Duesseldorf (DE); Thomas Mueller-Kirschbaum, Solingen (DE); Sven Mueller, Duisburg (DE); Arno Dueffels, Duesseldorf (DE)

Correspondence Address: Ratner Prestia, P.O. Box 980, Valley Forge, PA, 19482, US

(73) Assignee: Henkel AG & KGaA, Duesseldorf (DE)

(21) Appl. No.: 12/536,879

(22) Filed: Aug. 6, 2009

Related U.S. Application Data
(63) Continuation of application No. PCT/EP2007/061753, filed on Oct. 31, 2007.

(30) Foreign Application Priority Data
Feb. 6, 2007 (DE) 10 2007 006 627.0
Feb. 6, 2007 (DE) 10 2007 006 628.7
Feb. 6, 2007 (DE) 10 2007 006 629.7
Feb. 6, 2007 (DE) 10 2007 006 630.0
Sep. 4, 2007 (EP) PCT/EP2007/059203
Sep. 17, 2007 (DE) 10 2007 044 417.8
Sep. 17, 2007 (DE) 10 2007 044 418.6

(51) Int. Cl. A47L 15/44; C11D 3/37

(52) U.S. Cl. 134/25.2; 510/230

(57) ABSTRACT

Phosphate-free, bleaching agent-containing dishwasher detergents which contain a) citrate, b) bleaching catalyst selected from the group consisting of the bleach-boosting transition metal salts and transition metal complexes, c) copolymer(s) which comprise i) one or more acid group-containing monomer, ii) one or more additional hydrophobic monomer. The detergents have an improved bleaching action.

### CROSS-REFERENCE TO RELATED APPLICATIONS

This application is a continuation under 35 U.S.C. §§120 and 365(c) of International Application PCT/EP2007/061753, filed Oct. 31, 2007. This application also claims priority under 35 U.S.C. §119 of DE 10 2007 006 627.0, filed Feb. 6, 2007, DE 10 2007 006 630.0, filed Feb. 6, 2007, DE 10 2007 006 629.7, filed Feb. 6, 2007, DE 10 2007 006 628.7, filed Feb. 6, 2007, PCT/EP2007/059203, filed Sep. 4, 2007, DE 10 2007 044 417.8, filed Sep. 17, 2007 and DE 10 2007 044 418.6, filed Sep. 17, 2007. The disclosures of PCT/EP2007/061753, DE 10 2007 006 627.0, DE 10 2007 006 630.0, DE 10 2007 006 629.7, DE 10 2007 006 628.7, PCT/EP2007/059203, DE 10 2007 044 417.8, and DE 10 2007 044 418.6 are incorporated herein by reference in their entirety.

### BACKGROUND OF THE INVENTION

The present patent application describes detergents, in particular cleaning agents for automatic dishwashing. The present application in particular provides phosphate-free automatic dishwashing agents which contain bleaching catalysts.

More stringent requirements are today often applied to machine washed dishes than are applied to hand washed dishes. For instance, a dish which is at first glance completely clean of food residues is not deemed to be perfect if it still exhibits discoloration after automatic dishwashing which results for example from the deposition of vegetable dyes on the surface of the dish.

To achieve spotless dishes, bleaching agents are used in automatic dishwashing agents. To activate this bleaching agent and in order to achieve an improved bleaching action at temperatures of 60° C. and below, automatic dishwashing agents generally additionally contain bleaching activators or bleaching catalysts, bleaching catalysts in particular having proven particularly effective.

Bleaching catalysts are used in automatic dishwashing agents preferably in the form of premanufactured granules. For instance, European patents EP 458 397 B1 (Unilever), EP 458 398 B1 (Unilever) and EP 530 870 B1 (Unilever) describe bleaching catalysts based on various manganese-containing transition metal complexes.

Methods for producing bleaching catalyst granules are disclosed in published patent applications EP 544 440 A2 (Unilever) and WO 95/06710 A1 (Unilever). The distinguishing feature of the method described therein is the use of large quantities of binder, optionally used in the form of melts, said procedure involving cooling and/or drying stages which require the use of additional apparatuses such as fluidized bed installations.

Despite their undisputed bleaching action, however, bleaching catalysts cannot in every respect be deemed satisfactory for a person skilled in the art. For instance, despite the use of bleaching catalysts, unexpectedly poor bleaching effects are frequently observed, in particular in low-alkali, for example phosphate-free automatic dishwashing agents.

### DESCRIPTION OF THE INVENTION

If the light of this initial situation, the object of the present application was accordingly to provide a phosphate-free automatic dishwashing agent which displays improved bleaching action.

It has surprisingly been found that the bleaching action of bleaching catalysts from the group of bleach-boosting transition metal salts and transition metal complexes may be enhanced by the addition of hydrophobically modified acid-containing copolymers.

The present application accordingly firstly provides a phosphate-free automatic dishwashing agent containing bleaching agent, which automatic dishwashing agent contains
a) citrate
b) bleach catalyst selected from the group of bleach-boosting transition metal salts and transition metal complexes
c) copolymer(s), comprising

i) monomer(s) containing acid groups

ii) further hydrophobic monomer(s)

A first distinguishing component of preparations according to the invention is citrate. The term “citrate” here covers both citric acid and the salts thereof, in particular the alkali metal salts thereof. Particularly preferred automatic dishwashing agents according to the invention contain citrate in quantities of from 5 to 60 wt. %, preferably of 10 to 55 wt. % and in particular of 15 to 50 wt. %. With regard to bleaching performance, citrate or citric acid, in combination with the bleach catalyst and the hydrophobically modified copolymer, have proven particularly effective over other builders.

In addition to citrates, the automatic dishwashing agent according to the invention may contain additional builders, in particular silicates, carbonates or organic cobuilders.

Automatic dishwashing agents according to the invention preferentially contain as builder crystalline layered silicates of the general formula NaMSiₓO₂ₓ₊₁.yH₂O, in which M represents sodium or hydrogen, x is a number from 1.9 to 22, preferably from 1.9 to 4, particularly preferred values for x being 2, 3 or 4, and y denotes a number from 0 to 33, preferably from 0 to 20.

Amorphous sodium silicates may also be used which have an Na₂O:SiO₂ modulus of 1:2 to 1:3.3, preferably of 1:2 to 1:2.8 and in particular of 1:2 to 1:2.6, which are preferably dissolution-retarded and exhibit secondary washing characteristics.

Automatic dishwashing agents preferred for the purposes of the present invention contain 1 to 15 wt. % preferably 2 to 12 wt. % and in particular 2 to 8 wt. % of silicate(s).

It is particularly preferred to use carbonate(s) and/or hydrogencarbonate(s), preferably alkali metal carbonate(s), particularly preferably sodium carbonate, in quantities of 5 to 50 wt. %, preferably of 10 to 40 wt. % and in particular of 15 to 30 wt. %, in each case relative to the weight of the automatic dishwashing agent.

Organic cobuilders which may in particular be mentioned are polycarboxylates/polycarboxylic acids, polymeric carboxylates, aspartic acid, polyacetals, dextrins and organic cobuilders, including phosphonates. These classes of substances are described below.

Usable organic builder materials are for example polycarboxylic acids usable in the form of the free acid and/or the sodium salts thereof, polycarboxylic acids being taken to mean those carboxylic acids which bear more than one acid function. Examples are adipic acid, succinic acid, glutaric acid, malic acid, tartaric acid, maleic acid, fumaric acid, saccharic acids, aminocarboxylic acids, nitrilotriacetic acid (NTA), provided that there are no environmental objections against such use, and mixtures of these. Apart from their builder action, the free acids typically also have the property of an acidifying component and so also serve to establish a lower and gentler pH value for washing or cleaning agents. Succinic acid, glutaric acid, adipic acid, gluconic acid and any desired mixtures of these may in particular be mentioned.

Further suitable builders are polymeric polycarboxylates, these being for example the alkali metal salts of polyacrylic acid or polymethacrylic acid, for example those with a relative molecular mass of 500 to 70000 g/mol.

Suitable polymers are in particular polyacrylates, which preferably have a molecular mass of 2000 to 20000 g/mol. Due to their superior solubility, the short-chain polyacrylates from this group may in turn be preferred, these having molar masses of from 2000 to 10000 g/mol, and particularly preferably of from 3000 to 5000 g/mol.

Also suitable are copolymeric polycarboxylates, in particular those of acrylic acid with methacrylic acid and acrylic acid or methacrylic acid with maleic acid. Copolymers of acrylic acid with maleic acid containing 50 to 90 wt. % acrylic acid and 50 to 10 wt. % maleic acid have proven particularly suitable. Their relative molecular mass, relative to free acids, amounts in general to 2000 to 70000 g/mol, preferably 20000 to 50000 g/mol and in particular 30000 to 40000 g/mol.

The content of (co)polymeric polycarboxylates in the preferred automatic dishwashing agents preferably amounts to 0.5 to 20 wt. % and in particular to 3 to 10 wt. %, in each case relative to the total weight of the automatic dishwashing agents.

Preferred automatic dishwashing agents according to the invention contain no carboxymethyl inulin.

In addition to 1-hydroxyethane-1,1-diphosphonic acid, the complexing phosphonates comprise a series of different compounds such as for example diethylenetriaminepenta(methylenephosphonic acid) (DTPMP). Hydroxyalkane- or aminoalkanephosphonates in particular are preferred in the present application. Among hydroxyalkanephosphonates, 1-hydroxyethane-1,1-diphosphonate (HEDP) is of particular significance as a cobuilder. It is preferably used as a sodium salt, the disodium salt exhibiting a neutral reaction and the tetrasodium salt an alkaline (pH 9) reaction. Aminoalkanephosphonates which may preferably be considered are ethylenediaminetetramethylenephosphonate (EDTMP), diethylenetriaminepentamethylenephosphonate (DTPMP) as well as the higher homologs thereof. They are preferably used in the form of the sodium salts which exhibit a neutral reaction, for example as the hexasodium salt of EDTMP or as the hepta- and octasodium salt of DTPMP. From the class of phosphonates, HEDP is here preferably used as a builder. Aminoalkanephosphonates furthermore exhibit a pronounced heavy metal binding capacity. It may accordingly be preferred, especially if the preparations also contain bleach, to use aminoalkanephosphonates, in particular DTPMP, or mixtures of the stated phosphonates.

A automatic dishwashing agent which is preferred for the purposes of the present application contains one or more phosphonate(s) from the group
a) aminotrimethylenephosphonic acid (ATMP) and/or the salts thereof;
b) ethylenediaminetetra(methylenephosphonic acid) (EDTMP) and/or the salts thereof;
c) diethylenetriaminepenta(methylenephosphonic acid) (DTPMP) and/or the salts thereof;
d) 1-hydroxyethane-1,1-diphosphonic acid (HEDP) and/or the salts thereof;
e) 2-phosphonobutane-1,2,4-tricarboxylic acid (PBTC) and/or the salts thereof;
f) hexamethylenediaminetetra(methylenephosphonic acid) (HDTMP) and/or the salts thereof;
g) nitrilotri(methylenephosphonic acid) (NTMP) and/or the salts thereof.

Particularly preferred automatic dishwashing agents are those which contain 1-hydroxyethane-1,1-diphosphonic acid (HEDP) or diethylenetriaminepenta(methylenephosphonic acid) (DTPMP) as phosphonates.

The automatic dishwashing agents according to the invention may, of course, contain two or more different phosphonates.

The proportion by weight of the phosphonates amounts preferably to 0.5 to 14 wt. %, preferably 1 to 12 wt. % and in particular 2 to 8 wt. %.

A second essential component of dishwashing agents according to the invention is a bleaching system comprising bleaching agent and bleach catalyst.

As preferred bleaching agent, automatic dishwashing agents according to the invention contain an oxygen bleaching agent from the group comprising sodium percarbonate, sodium perborate tetrahydrate and sodium perborate monohydrate. Further usable bleaching agents are, for example, peroxypyrophosphates, citrate perhydrates and H₂O₂-releasing per-acidic salts or per-acids, such as perbenzoates, peroxophthalates, diperazelaic acid, phthaloimino per-acid or diperdodecanedioic acid.

Bleaching agents from the group of organic bleaching agents may furthermore also be used. Typical organic bleaching agents are diacyl peroxides, such as for example dibenzoyl peroxide. Further typical organic bleaching agents are peroxy acids, with examples which may in particular be mentioned being alkylperoxy acids and arylperoxy acids. Sodium percarbonate is particularly preferred due to its good bleaching performance.

Preferred automatic dishwashing agents are characterized in that the dishwashing agent contains 1.0 to 20 wt. %, preferably 4.0 to 18 wt. % and in particular 8 to 15 wt. % of an oxygen bleaching agent, preferably 1.0 to 20 wt. %, preferably 4.0 to 18 wt. % and in particular 8 to 15 wt. % of sodium percarbonate.

The present application accordingly preferably provides a phosphate-free automatic dishwashing agent which contains
a) citrate
b) bleach catalyst selected from the group of bleach-boosting transition metal salts and transition metal complexes
c) copolymer(s), comprising

i) monomer(s) containing acid groups

ii) further hydrophobic monomer(s)
d) 2.0 to 15 wt. % of sodium percarbonate.

The bleaching activators comprise bleach-boosting transition metal salts or transition metal complexes such as for example Mn, Fe, Co, Ru or Mo salen complexes or carbonyl complexes. Mn, Fe, Co, Ru, Mo, Ti, V and Cu complexes with nitrogenous tripod ligands and Co, Fe, Cu and Ru ammine complexes may also be used as bleach catalysts.

Complexes of manganese in oxidation state II, III, IV or IV which preferably contain one or more macrocyclic ligand(s) with N, NR, PR, O and/or S donor functions are particularly preferentially used. Ligands which comprise nitrogen donor functions are preferably used. It is in this case particularly preferred to use bleach catalyst(s) in the preparations according to the invention, which contain as macromolecular ligand 1,4,7-trimethyl-1,4,7-triazacyclononane (Me-TACN), 1,4,7-triazacyclononane (TACN), 1,5,9-trimethyl-1,5,9-triazacyclododecane (Me-TACD), 2-methyl-1,4,7-trimethyl-1,4,7-triazacyclononane (Me/Me-TACN) and/or 2-methyl-1,4,7-triazacyclononane (Me/TACN). Suitable manganese complexes are for example [Mn^{III}₂(μO)₁(μOAc)₂(TACN)₂](ClO₄)₂, [Mn^{III}Mn^{IV}(μO)2(μ-OAc)₁(TACN)₂](BPh₄)₂, [Mn^{IV}₄(μ-O)₆(TACN)₄](ClO₄)₄, [Mn^{III}₂(μ-O)₁(μ-OAc)₂(Me-TACN)₂](ClO₄)₂, [Mn^{III}Mn^{IV}(μ-O)₁(μ-OAc)₂(Me-TACN)₂](ClO₄)₃, [Mn^{IV}₂(μ-O)₃(Me-TACN)₂](PF₆)₂ and [Mn^{IV}₂(μ-O)₃(Me/Me-TACN)₂](PF₆)₂ (OAc=OC(O)CH₃).

Boosted bleaching performance brought about by the active ingredient combination according to the invention comprising citrate, bleach catalyst and hydrophobically modified polymer could in particular be observed in manganese-containing bleaching catalysts.

Automatic dishwashing agents which are characterized in that they contain a bleach catalyst selected from the group of bleach-boosting transition metal salts and transition metal complexes, preferably from the group of complexes of manganese with 1,4,7-trimethyl-1,4,7-triazacyclononane (Me₃-TACN) or 1,2,4,7-tetramethyl-1,4,7-triazacyclononane (Me₄-TACN), are particularly preferred according to the invention.

The above-stated bleaching catalysts selected from the group of bleach-boosting transition metal salts and transition metal complexes, in particular with Mn and Co central atoms are preferably used in a quantity of up to 5 wt. %, in particular of 0.01 wt. % to 3.0 wt. %, preferably of 0.02 wt. % to 2.0 wt. % and in particular of 0.02 to 1.0 wt. %, in each case relative to the total weight of the preparations containing bleaching activator. In specific cases, however, more bleaching activator may also be used.

The present application accordingly also preferably provides a phosphate-free automatic dishwashing agent which contains
a) citrate
b) 0.01 to 3.0 wt. % of bleach catalyst selected from the group of bleach-boosting transition metal salts and transition metal complexes
c) copolymer(s), comprising

i) monomer(s) containing acid groups

ii) further hydrophobic monomer(s)
d) 2.0 to 15 wt. % of sodium percarbonate.

In a preferred embodiment, the bleaching system according to the invention comprising bleaching agent and bleach catalyst is supplemented with a bleaching activator. Bleaching activators which may be used are compounds which, under perhydrolysis conditions, yield aliphatic peroxycarboxylic acids with preferably 1 to 10 C atoms, in particular 2 to 4 C atoms, and/or optionally substituted perbenzoic acid. Suitable substances are those which bear O- and/or N-acyl groups having the stated number of C atoms and/or optionally substituted benzoyl groups. Polyacylated alkylenediamines are preferred, tetraacetylethylenediamine (TAED) having proved particularly suitable.

These bleaching activators, in particular TAED, are preferably used in quantities of up to 10 wt. %, in particular of 0.1 wt. % to 8 wt. %, particularly of 2 to 8 wt. % and particularly preferably of 2 to 6 wt. %, in each case relative to the total weight of the preparations containing bleaching activator.

Addition of the bleaching activator allowed a further increase in bleaching action to be achieved.

The automatic dishwashing agents contain a hydrophobically modified copolymer, comprising a monomer containing acid groups and a hydrophobic monomer, as the third essential component. The proportion by weight of this copolymer relative to the total weight of the automatic dishwashing agent amounts preferably to 0.1 to 30 wt. %, preferably to 0.5 to 25 wt. % and in particular to 1.0 to 20 wt. %.

Automatic dishwashing agents which are characterized in that the dishwashing agent contains 0.1 to 30 wt. %, preferably 0.5 to 25 wt. % and in particular 1.0 to 20 wt. % of copolymer, comprising

i) monomer(s) containing acid groups

ii) further hydrophobic monomer(s)

are preferred according to the invention.

The following table shows some example formulations of such preferred phosphate-free automatic dishwashing agents:

| | Formu- | Formu- | Formu- | Formu- |
|---|---|---|---|---|
| | lation 1 | lation 2 | lation 3 | lation 4 |
| Ingredient | [wt. %] | [wt. %] | [wt. %] | [wt. %] |
| Citrate | 5 to 60 | 10 to 55 | 15 to 50 | 15 to 50 |
| Sodium | 1 to 20 | 2 to 15 | 4 to 10 | 4 to 10 |
| percarbonate | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Misc | Ad 100 | Ad 100 | Ad 100 | Ad 100 |

¹Copolymer(s), comprising
i) monomer(s) containing acid groups
ii) further hydrophobic monomer(s)

The above-stated copolymers c) may vary with regard to the chemical nature of their monomers. For instance, the copolymer may contain further ionic or nonionic monomers in addition to the monomers i) and ii) in the copolymer.

With regard to improving bleaching performance, those copolymers in particular have proven particularly effective in which the monomer i) containing acid groups comprises a carboxylic acid group and/or a sulfonic acid group.

Preference is also given to those copolymers in which the monomer ii) is selected from the group of mono- or polyunsaturated hydrocarbon residues with 2 to 26 carbon atoms.

A first group of preferred automatic dishwashing agents is therefore characterized in that the dishwashing agent contains copolymer(s) c), which comprise(s)
i) monomers from the group of mono- or polyunsaturated carboxylic acids
ii) monomers from the group of mono- or polyunsaturated hydrocarbon residues with 2 to 26 carbon atoms.

The following table shows some example formulations of such preferred phosphate-free automatic dishwashing agents:

| | Formu- | Formu- | Formu- | Formu- |
|---|---|---|---|---|
| | lation 5 | lation 6 | lation 7 | lation 8 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Misc | Ad 100 | Ad 100 | Ad 100 | Ad 100 |

Copolymer comprising
i) monomers from the group of mono- or polyunsaturated carboxylic acids
ii) monomers from the group of mono- or polyunsaturated hydrocarbon residues with 2 to 26 carbon atoms

A second group of preferred automatic dishwashing agents is therefore characterized in that the dishwashing agent contains copolymer(s) c), which comprise(s)
i) monomers from the group of mono- or polyunsaturated sulfonic acids
ii) monomers from the group of mono- or polyunsaturated hydrocarbon residues with 2 to 26 carbon atoms.

These preferentially used copolymers containing sulfonic acid groups contain as monomer i) monomers preferably containing sulfonic acid groups of the formula R⁵(R⁶)C═C(R⁷)—X—SO₃H, in which R⁵ to R⁷ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH, or denote —COOH or —COOR⁴, R⁴ being a saturated or unsaturated, straight-chain or branched hydrocarbon residue with 1 to 12 carbon atoms, and X denotes an optionally present spacer group, which is selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Preferred among these monomers are those of the formulae

H₂C═CH—XSO₃H

H₂C═C(CH₃)—X—SO₃H

HO₃S—X—(R⁶)C═C(R⁷)—X—SO₃H,

in which R⁶ and R⁷ are mutually independently selected from —H, —CH₃, —CH₂CH₃, —CH₂CH₂CH₃, —CH(CH₃)₂ and X denotes an optionally present spacer group, which is selected from —(CH₂)ₙ— with n=0 to 4, —COO—(CH₂)ₖ— with k=1 to 6, —C(O)—NH—C(CH₃)₂— and —C(O)—NH—CH(CH₂CH₃)—.

Particularly preferred monomers containing sulfonic acid groups are here 1-acrylamido-1-propanesulfonic acid, 2-acrylamido-2-propanesulfonic acid, 2-acrylamido-2-methyl-1-propanesulfonic acid, 2-methacrylamido-2-methyl-1-propanesulfonic acid, 3-methacrylamido-2-hydroxypropanesulfonic acid, allylsulfonic acid, methallylsulfonic acid, allyloxybenzenesulfonic acid, methallyloxybenzenesulfonic acid, 2-hydroxy-3-(2-propenyloxy)propanesulfonic acid, 2-methyl-2-propene-1-sulfonic acid, styrenesulfonic acid, vinylsulfonic acid, 3-sulfopropyl acrylate, 3-sulfopropyl methacrylate, sulfomethacrylamide, sulfomethylmethacrylamide and mixtures of the stated acids or the water-soluble salts thereof.

The sulfonic acid groups may be present in the polymers entirely or in part in neutralized form, i.e. the acidic hydrogen atom of the sulfonic acid group may be replaced in some or all of the sulfonic acid groups with metal ions, preferably alkali metal ions and in particular with sodium ions. It is preferred according to the invention to use copolymers containing partially or completely neutralized sulfonic acid groups.

In those copolymers solely containing monomers from groups i) and ii), the monomer distribution of the copolymers preferably used according to the invention preferably amounts in each case to 5 to 95 wt. % of i) or ii), particularly preferably 50 to 90 wt. % of monomer from group i) and 10 to 50 wt. % of monomer from group ii), in each case relative to the polymer.

The molar mass of the sulfo copolymers preferably used according to the invention may be varied in order to tailor the properties of the polymers to the desired intended application. Preferred automatic dishwashing agents are characterized in that the copolymers have molar masses of 2000 to 200,000 gmol⁻¹, preferably of 4000 to 25,000 gmol⁻¹ and in particular of 5000 to 15,000 gmol⁻¹.

In a first preferred embodiment, in addition to at least one monomer containing sulfonic acid groups, the copolymers furthermore comprise at least one additional ionic monomer.

The unsaturated carboxylic acids i) used with particular preference in these special copolymers (c) are unsaturated carboxylic acids of the formula R¹(R²)C═C(R³)COOH, in which R¹ to R³ mutually independently denote —H, —CH₃, a straight-chain or branched saturated alkyl residue with 2 to 12 carbon atoms, a straight-chain or branched, mono- or polyunsaturated alkenyl residue with 2 to 12 carbon atoms, alkyl or alkenyl residues substituted with —NH₂, —OH or —COOH as defined above or denote —COOH or —COOR⁴, R⁴ being a saturated or unsaturated, straight-chain or branched hydrocarbon residue with 1 to 12 carbon atoms.

Particularly preferred unsaturated carboxylic acids are acrylic acid, methacrylic acid, ethacrylic acid, -chloroacrylic acid, -cyanoacrylic acid, crotonic acid, -phenylacrylic acid, maleic acid, maleic anhydride, fumaric acid, itaconic acid, citraconic acid, methylenemalonic acid, sorbic acid, cinnamic acid or mixtures thereof.

In a first preferred embodiment, in addition to at least one monomer containing carboxylic acid groups, the copolymers furthermore comprise at least one additional ionic monomer.

The following table shows some example formulations of such preferred phosphate-free automatic dishwashing agents:

| | Formu- | Formu- | Formu- | Formu- |
|---|---|---|---|---|
| | lation 9 | lation 10 | lation 11 | lation 12 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Misc | Ad 100 | Ad 100 | Ad 100 | Ad 100 |

¹Copolymer comprising
i) monomers from the group of mono- or polyunsaturated sulfonic acids
ii) monomers from the group of mono- or polyunsaturated hydrocarbon residues with 2 to 26 carbon atoms

The unsaturated hydrocarbon residues ii) used in the copolymers c), i.e. for example in the above-described preferred copolymers c) which comprise a monomer i) containing carboxylic acid or sulfonic acid nonionic monomers, preferably take the form of monomers of the general formula R¹(R²)C═C(R³)—X—R⁴, in which R¹ to R³ mutually independently denote —H, —CH₃ or —C₂H₅, X denotes an optionally present spacer group which is selected from —CH₂—, —C(O)O— and —C(O)—NH—, and R⁴ denotes a straight-chain or branched saturated alkyl residue with 2 to 22 carbon atoms or denotes an unsaturated, preferably aromatic residue with 6 to 22 carbon atoms.

Particularly preferred unsaturated hydrocarbon residues are butene, isobutene, pentene, 3-methylbutene, 2-methylbutene, cyclopentene, hexene, 1-hexene, 2-methyl-1-pentene, 3-methyl-1-pentene, cyclohexene, methylcyclopentene, cycloheptene, methylcyclohexene, 2,4,4-trimethyl-1-pentene, 2,4,4-trimethyl-2-pentene, 2,3-dimethyl-1-hexene, 2,4-dimethyl-1-hexene, 2,5-dimethyl-1-hexene, 3,5-dimethyl-1-hexene, 4,4-dimethyl-1-hexane, ethylcyclohexyne, 1-octene, -olefins with 10 or more carbon atoms such as for example 1-decene, 1-dodecene, 1-hexadecene, 1-octadecene and C22-olefin, 2-styrene, -methylstyrene, 3-methylstyrene, 4-propylstryene, 4-cyclohexylstyrene, 4-dodecylstyrene, 2-ethyl-4-benzylstyrene, 1-vinylnaphthalene, 2-vinylnaphthalene, methyl acrylate, ethyl acrylate, propyl acrylate, butyl acrylate, pentyl acrylate, hexyl acrylate, methyl methacrylate, N-(methyl)acrylamide, 2-ethylhexyl acrylate, 2-ethylhexyl methacrylate, N-(2-ethylhexyl)acrylamide, octyl acrylate, octyl methacrylate, N-(octyl)acrylamide, lauryl acrylate, lauryl methacrylate, N-(lauryl)acrylamide, stearyl acrylate, stearyl methacrylate, N-(stearyl)acrylamide, behenyl acrylate, behenyl methacrylate and N-(behenyl)acrylamide or mixtures thereof.

In addition to the above-described hydrophobically modified copolymers, the automatic dishwashing agent according to the invention may contain further copolymers, copolymer(s) comprising
i) monomer(s) containing carboxylic acid groups
ii) monomer(s) containing sulfonic acid groups
   being preferred according to the invention. These copolymers are preferably used in quantities of 0.1 to 30 wt. %, preferably of 0.5 to 25 wt. % and in particular of 1.0 to 20 wt. %, in each case relative to the total weight of the automatic dishwashing agent.

The preparations according to the invention may furthermore contain surfactants. Surfactants are taken to encompass nonionic, anionic, cationic and amphoteric surfactants.

The automatic dishwashing agents particularly preferentially contain nonionic surfactant(s), the proportion by weight of the nonionic surfactants(s) relative to total weight of the automatic dishwashing agent preferably amounting to between 1 to 10 wt. %, preferably 2 to 8 wt. % and in particular 3 to 6 wt. %.

Any nonionic surfactants known to a person skilled in the art may be used as the nonionic surfactants. Examples of suitable nonionic surfactants are alkyl glycosides of the general formula RO(G)ₓ, in which R corresponds to a primary straight-chain or methyl-branched aliphatic residue, in particular methyl-branched in position 2, with 8 to 22, preferably 12 to 18 C atoms and G is the symbol which denotes a glycose unit with 5 or 6 C atoms, preferably glucose. The degree of oligomerization x, which indicates the distribution of monoglycosides and oligoglycosides, is any desired number between 1 and 10; x is preferably 1.2 to 1.4.

Nonionic surfactants of the amine oxide type, for example N-coconut alkyl-N,N-dimethylamine oxide and N-tallow alcohol-N,N-dihydroxyethylamine oxide, and of the fatty acid alkanolamide type may also be suitable. The quantity of these nonionic surfactants preferably amounts to no more than that of the ethoxylated fatty alcohols, in particular no more than half the quantity thereof.

A further class of preferably used nonionic surfactants, which may be used either as sole nonionic surfactant or in combination with other nonionic surfactants, are alkoxylated, preferably ethoxylated or ethoxylated and propoxylated fatty acid alkyl esters, preferably with 1 to 4 carbon atoms in the alkyl chain.

Low-foaming nonionic surfactants are used as preferred surfactants. Washing or cleaning agents, in particular cleaning agents for automatic dishwashing, particularly preferentially contain nonionic surfactants from the group of alkoxylated alcohols. Alkoxylated, advantageously ethoxylated, in particular primary alcohols with preferably 8 to 18 C atoms and on average 1 to 12 mol of ethylene oxide (EO) per mol of alcohol, in which the alcohol residue may be linear or preferably methyl-branched in position 2 or may contain linear and methyl-branched residues in the mixture, as are usually present in oxo alcohol residues, are preferably used as nonionic surfactants. In particular, however, alcohol ethoxylates with linear residues prepared from alcohols of natural origin with 12 to 18 C atoms, for example from coconut, palm, tallow fat or oleyl alcohol, and on average 2 to 8 mol of EO per mol of alcohol are preferred. The preferred ethoxylated alcohols include for example C₁₂₋₁₄ alcohols with 3 EO to 4 EO, C₉₋₁₁ alcohol with 7 EO, C₁₃₋₁₅ alcohols with 3 EO, 5 EO, 7 EO or 8 EO, C₁₂₋₁₈ alcohols with 3 EO, 5 EO or 7 EO and mixtures of these, such as mixtures of C₁₂₋₁₄ alcohol with 3 EO and C₁₂₋₁₈ alcohol with 5 EO. The stated degrees of ethoxylation are statistical averages which, for a specific product, may be an integer or a fractional number. Preferred alcohol ethoxylates have a narrow homolog distribution (narrow range ethoxylates, NRE). In addition to these nonionic surfactants, fatty alcohols with more than 12 EO may also be used. Examples of these are tallow fatty alcohol with 14 EO, 25 EO, 30 EO or 40 EO.

Ethoxylated nonionic surfactants which were obtained from C₆₋₂₀ monohydroxyalkanols or C₆₋₂₀ alkylphenols or C₁₆₋₂₀ fatty alcohols and more than 12 mol, preferably more than 15 mol and in particular more than 20 mol of ethylene oxide per mol of alcohol are accordingly particularly preferentially used. One particularly preferred nonionic surfactant is obtained from a straight-chain fatty alcohol having 16 to 20 carbon atoms (C₁₆₋₂₀ alcohol), preferably a C₁₈ alcohol, and at least 12 mol, preferably at least 15 mol and in particular at least 20 mol of ethylene oxide. Among these, “narrow range ethoxylates” are particularly preferred.

Combinations of one or more tallow fatty alcohols with 20 to 30 EO and silicone defoamers are particularly preferentially used.

In particular, nonionic surfactants having a melting point of above room temperature are preferred. Nonionic surfactant(s) with a melting point of above 20° C., preferably of above 25° C., particularly preferably of between 25 and 60° C. and in particular of between 26.6 and 43.3° C., is/are particularly preferred.

Suitable nonionic surfactants which have melting or softening points in the stated temperature range are for example low-foaming nonionic surfactants which may be solid or highly viscous at room temperature. If nonionic surfactants which are highly viscous at room temperature are used, it is preferred for them to have a viscosity of above 20 Pa·s, preferably of above 35 Pa·s and in particular of above 40 Pa·s. Depending on their intended application, nonionic surfactants which have a waxy consistency at room temperature are also preferred.

Nonionic surfactants from the group of alkoxylated alcohols, particularly preferably from the group of mixed alkoxylated alcohols and in particular from the group of EO-AO-EO nonionic surfactants, are likewise particularly preferentially used.

The nonionic surfactant which is solid at room temperature preferably comprises propylene oxide units in its molecule. Such PO units preferably constitute up to 25 wt. %, particularly preferably up to 20 wt. % and in particular up to 15 wt. % of the total molar mass of the nonionic surfactant. Particularly preferred nonionic surfactants are ethoxylated monohydroxyalkanols or alkylphenols which additionally comprise polyoxyethylene/polyoxypropylene block copolymer units. The alcohol or alkylphenol moiety of such nonionic surfactant molecules here preferably constitutes more than 30 wt. %, particularly preferably more than 50 wt. % and in particular more than 70 wt. % of the total molar mass of such nonionic surfactants. Preferred preparations are characterized in that they contain ethoxylated and propoxylated nonionic surfactants, in which the propylene oxide units constitute in each molecule up to 25 wt. %, preferably up to 20 wt. % and in particular up to 15 wt. % of the total molar mass of the nonionic surfactant.

Preferably used nonionic surfactants originate from the groups comprising alkoxylated nonionic surfactants, in particular ethoxylated primary alcohols and mixtures of these surfactants with structurally complex surfactants such as polyoxypropylene/polyoxyethylene/polyoxypropylene ((PO/EO/PO) surfactants). Such (PO/EO/PO) nonionic surfactants are furthermore distinguished by good foam control.

Further nonionic surfactants with a melting point above room temperature which are particularly preferably to be used contain 40 to 70% of a polyoxypropylene/polyoxyethylene/polyoxypropylene block polymer blend, which contains 75 wt. % of a reverse block copolymer of polyoxyethylene and polyoxypropylene with 17 mol of ethylene oxide and 44 mol of propylene oxide and 25 wt. % of a block copolymer of polyoxyethylene and polyoxypropylene, initiated with trimethylolpropane and containing 24 mol of ethylene oxide and 99 mol of propylene oxide per mol of trimethylolpropane.

Nonionic surfactants which have proved to be particularly preferred for the purposes of the present invention are low-foaming nonionic surfactants which comprise alternating ethylene oxide and alkylene oxide units. Among these, surfactants with EO-AO-EO-AO blocks are in turn preferred, with in each case one to ten EO or AO groups being attached to one another before being followed by a block of the respective other groups. Preferred nonionic surfactants are those of the general formula

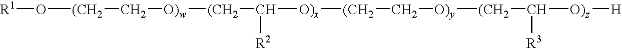

in which R¹ denotes a straight-chain or branched, saturated or mono- or polyunsaturated C₆₋₂₄ alkyl or alkenyl residue; each group R² or R³ is mutually independently selected from —CH₃, —CH₂CH₃, —CH₂CH₂—CH₃, CH(CH₃)₂ and the indices w, x, y, z mutually independently denote integers from 1 to 6.

The preferred nonionic surfactants of the above formula may be produced by known methods from the corresponding alcohols R¹—OH and ethylene or alkylene oxide. Residue R¹ in the above formula may vary depending on the origin of the alcohol. If natural sources are used, the residue R¹ comprises an even number of carbon atoms and is generally unbranched, preference being given to linear residues from alcohols of natural origin with 12 to 18 C atoms, for example from coconut, palm, tallow fat or oleyl alcohol. Alcohols obtainable from synthetic sources are for example Guerbet alcohols or residues methyl-branched in position 2 or linear and methyl-branched residues in a mixture as are conventionally present in oxo alcohol residues. Irrespective of the nature of the alcohol used for producing nonionic surfactants contained in the preparations, preferred nonionic surfactants are those in which R¹ in the above formula denotes an alkyl residue with 6 to 24, preferably 8 to 20, particularly preferably 9 to 15 and in particular 9 to 11 carbon atoms.

Apart from propylene oxide, butylene oxide may in particular be considered as the alkylene oxide unit which alternates with the ethylene oxide unit in preferred nonionic surfactants. However, further alkylene oxides, in which R² or R³ are mutually independently selected from —CH₂CH₂—CH₃ or —CH(CH₃)₂ are also suitable. Nonionic surfactants of the above formula which are preferably used are those in which R² or R³ denotes a residue —CH₃, w and x mutually independently denote values of 3 or 4 and y and z mutually independently denote values of 1 or 2.

In summary, preferred nonionic surfactants are in particular those which comprise a C₉₋₁₅ alkyl residue with 1 to 4 ethylene oxide units, followed by 1 to 4 propylene oxide units, followed by 1 to 4 ethylene oxide units, followed by 1 to 4 propylene oxide units. In aqueous solution, these surfactants exhibit the necessary low viscosity and may particularly preferentially be used according to the invention.

Surfactants of the general formula R¹—CH(OH)CH₂O-(AO)w-(A′O)ₓ-(A″O)_{y}-(A′″O)_{z}—R², in which R¹ and R² mutually independently denote a straight-chain or branched, saturated or mono- or polyunsaturated C₂₋₄₀ alkyl or alkenyl residue; A, A′, A″ and A′″ mutually independently denote a residue from the group —CH₂CH₂, —CH₂CH₂—CH₂, —CH₂—CH(CH₃), —CH₂—CH₂—CH₂—CH₂, —CH₂—CH(CH₃)—CH₂—, —CH₂—CH(CH₂—CH₃); and w, x, y and z denote values between 0.5 and 90, with x, y and/or z possibly also being 0, are preferred according to the invention.

In particular, preferred end group-terminated poly(oxyalkylated) nonionic surfactants are those which, according to the formula R¹O[CH₂CH₂O]ₓCH₂CH(OH)R², in addition to a residue R¹, which denotes linear or branched, saturated or unsaturated, aliphatic or aromatic hydrocarbon residues with 2 to 30 carbon atoms, preferably with 4 to 22 carbon atoms, furthermore comprise a linear or branched, saturated or unsaturated, aliphatic or aromatic hydrocarbon residue R² with 1 to 30 carbon atoms, x denoting values between 1 and 90, preferably values between 30 and 80 and in particular values between 30 and 60.

Particularly preferred surfactants are those of the formula R¹O[CH₂CH(CH₃)O]ₓ[CH₂CH₂O]_{y}CH₂CH(OH)R², in which R¹ denotes a linear or branched aliphatic hydrocarbon residue with 4 to 18 carbon atoms or mixtures thereof, R² denotes a linear or branched hydrocarbon residue with 2 to 26 carbon atoms or mixtures thereof and x denotes values between 0.5 and 1.5 and y denotes a value of at least 15.

Thanks to the use of the above-described nonionic surfactants with a free hydroxyl group on one of the two terminal alkyl residues, it is possible to achieve a distinct improvement in the formation of film deposits in automatic dishwashing in comparison with conventional polyalkoxylated fatty alcohols without a free hydroxyl group.

Particularly preferred end group-terminated poly(oxyalkylated) nonionic surfactants are furthermore those of the formula R¹O[CH₂CH₂O]ₓ[CH₂CH(R³)O]_{y}CH₂CH(OH)R², in which R¹ and R² mutually independently denote a linear or branched, saturated or mono- or polyunsaturated hydrocarbon residue with 2 to 26 carbon atoms, R³ is mutually independently selected from —CH₃, —CH₂CH₃, —CH₂CH₂—CH₃, —CH(CH₃)₂, but preferably denotes —CH₃, and x and y mutually independently denote values between 1 and 32, with nonionic surfactants with R³═—CH₃ and values of x from 15 to 32 and y from 0.5 and 1.5 being very particularly preferred.

Further preferably usable nonionic surfactants are the end group-terminated poly(oxyalkylated) nonionic surfactants of the formula R¹O[CH₂CH(R³)O]ₓ[CH₂]ₖCH(OH)[CH₂]OR², in which R¹ and R² denote linear or branched, saturated or unsaturated, aliphatic or aromatic hydrocarbon residues with 1 to 30 carbon atoms, R³ denotes H or a methyl, ethyl, n-propyl, iso-propyl, n-butyl, 2-butyl or 2-methyl-2-butyl residue, x denotes values between 1 and 30, k and j denote values between 1 and 12, preferably between 1 and 5. If the value of x is ≧2, each R³ in the above formula may be R¹O[CH₂CH(R³)O]ₓ[CH₂]ₖCH(OH)[CH₂]ⱼOR² different. R¹ and R² are preferably linear or branched, saturated or unsaturated, aliphatic or aromatic hydrocarbon residues with 6 to 22 carbon atoms, residues with 8 to 18 C atoms being particularly preferred. H, —CH³ or —CH₂CH₃ are particularly preferred for the residue R₃. Particularly preferred values for x are in the range from 1 to 20, in particular from 6 to 15.

As described above, each R³ in the above formula may be different if x is ≧2. In this manner, it is possible to vary the alkylene oxide unit in the square brackets. For example, if x denotes 3, the residue R³ may be selected in order to form ethylene oxide (R³=H) or propylene oxide (R³═CH₃) units, which may be attached to one another in any sequence, for example (EO)(PO)(EO), (EO)(EO)(PO), (EO)(EO)(EO), (PO)(EO)(PO), (PO)(PO)(EO) and (PO)(PO)(PO). The value 3 for x has been selected here by way of example and may perfectly well be larger, the range of variation increasing as the value of x rises and for example comprising a large number of (EO) groups combined with a small number of (PO) groups, or vice versa.

Particularly preferred end group-terminated poly(oxyalkylated) alcohols of the above-stated formula have values of k=1 and j=1, such that the above formula simplifies to R¹O[CH₂CH(R³)O]ₓCH₂CH(OH)CH₂OR². In the latter-stated formula, R¹, R² and R³ are as defined above and x denotes numbers from 1 to 30, preferably from 1 to 20 and in particular from 6 to 18. Particularly preferred surfactants are those in which the residues R¹ and R² comprise 9 to 14 C atoms, R³ denotes H and x assumes values from 6 to 15.

The stated C chain lengths and degrees of ethoxylation or degrees of alkoxylation of the above-stated nonionic surfactants are statistical averages which, for a specific product, may be an integer or a fractional number. Due to production methods, commercial products of the stated formulae do not in the main consist of an individual representative, but instead of mixtures, whereby not only the C-chain lengths but also the degrees of ethoxylation or degrees of alkoxylation may be averages and consequently fractional numbers.

The above-stated nonionic surfactants may, of course, be used not only as individual substances, but also as surfactant mixtures of two, three, four or more surfactants. Surfactant mixtures do not here comprise mixtures of nonionic surfactants all of which fall within one of the above-stated general formulae, but instead such mixtures which contain two, three, four or more nonionic surfactants which may be described by various of the above-stated general formulae.

The following tables show-some example formulations of such preferred phosphate-free automatic dishwashing agents:

| | Formu- | Formu- | Formu- | Formu- |
|---|---|---|---|---|
| | lation 13 | lation 14 | lation 15 | lation 16 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Misc | Ad 100 | Ad 100 | Ad 100 | Ad 100 |

¹Copolymer comprising
i) monomers from the group of mono- or polyunsaturated carboxylic acids
ii) monomers from the group of mono- or polyunsaturated hydrocarbon residues with 2 to 26 carbon atoms

| | Formu- | Formu- | Formu- | Formu- |
|---|---|---|---|---|
| | lation 17 | lation 18 | lation 19 | lation 20 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Misc | Ad 100 | Ad 100 | Ad 100 | Ad 100 |

¹Copolymer comprising
i) monomers from the group of mono- or polyunsaturated sulfonic acids
ii) monomers from the group of mono- or polyunsaturated hydrocarbon residues with 2 to 26 carbon atoms

In addition to the ingredients described further above such as builders or bleaching agents and nonionic surfactants, preferred automatic dishwashing agents preferably contain further ingredients, preferably active ingredients from the group of polymers with a washing or cleaning action, enzymes, corrosion inhibitors, fragrances or dyes.

The group of polymers with a washing or cleaning action includes for example rinsing polymers and/or polymers with a water-softening action, in particular cationic or amphoteric polymers.

“Cationic polymers” for the purposes of the present invention are polymers which bear a positive charge in the polymer molecule. This may for example be achieved by (alkyl)ammonium groupings or other positively charged groups present in the polymer chain. Particularly preferred cationic polymers originate from the groups comprising quaternized cellulose derivatives, polysiloxanes with quaternary groups, cationic guar derivatives, polymeric dimethyidiallylammonium salts and the copolymers thereof with esters and amides of acrylic acid and methacrylic acid, copolymers of vinylpyrrolidone with quaternized derivatives of dialkylamino acrylate and methacrylate, vinylpyrrolidone/methoimidazolinium chloride copolymers, quaternized polyvinyl alcohols or the polymers known by the INCI names Polyquaternium 2, Polyquaternium 17, Polyquaternium 18 and Polyquaternium 27.

In addition to a positively charged group in the polymer chain, “amphoteric polymers” for the purposes of the present invention furthermore also comprise negatively charged groups or monomer units. These groups may for example comprise carboxylic acids, sulfonic acids or phosphonic acids.

Preferred washing or cleaning agents, in particular preferred automatic dishwashing agents, are characterized in that they contain a polymer a) which comprises monomer units of the formula R¹R²C═CR³R⁴, in which each residue R¹, R², R³, R⁴ is mutually independently selected from hydrogen, derivatized hydroxy groups, C₁₋₃₀ linear or branched alkyl groups, aryl, C₁₋₃₀ linear or branched alkyl groups substituted with aryl, polyalkoxylated alkyl groups, heteroatomic organic groups with at least one positive charge without charged nitrogen, at least one quaternized N atom or at least one amino group with a positive charge in the subrange of the pH range of 2 to 11, or salts thereof, with the proviso that at least one residue R¹, R², R³, R⁴ is a heteroatomic organic group with at least one positive charge without charged nitrogen, at least one quaternized N atom or at least one amino group with a positive charge. Cationic or amphoteric polymers which are particularly preferred for the purposes of the present application contain as monomer unit a compound of the general formula

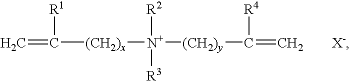

in which R¹ and R⁴ mutually independently denote H or a linear or branched hydrocarbon residue with 1 to 6 carbon atoms; R² and R³ mutually independently denote an alkyl, hydroxyalkyl or aminoalkyl group in which the alkyl residue is linear or branched and comprises between 1 and 6 carbon atoms, it preferably comprising a methyl group; x and y mutually independently denote integers between 1 and 3. X represents a counterion, preferably a counterion from the group comprising chloride, bromide, iodide, sulfate, hydrogensulfate, methosulfate, laurylsulfate, dodecylbenzenesulfonate, p-toluenesulfonate(tosylate), cumenesulfonate, xylenesulfonate, phosphate, citrate, formate, acetate or mixtures thereof.

Preferred residues R¹ and R⁴ in the above formula are selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH.

Very particularly preferred polymers are those which comprise a cationic monomer unit of the above general formula, in which R¹ and R⁴ denote H, R² and R³ denote methyl and x and y are in each case 1. The corresponding monomer unit of the formula

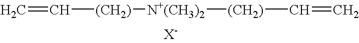

is also known as DADMAC (diallyldimethylammonium chloride) when X⁻ is chloride.

Further particularly preferred cationic or amphoteric polymers contain a monomer unit of the general formula

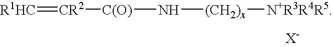

in which R¹, R², R³, R⁴ and R⁵ mutually independently denote a linear or branched, saturated or unsaturated alkyl or hydroxyalkyl residue with 1 to 6 carbon atoms, preferably denote a linear or branched alkyl residue selected from —CH₃, —CH₂—CH₃, —CH₂—CH₂—CH₃, —CH(CH₃)—CH₃, —CH₂—OH, —CH₂—CH₂—OH, —CH(OH)—CH₃, —CH₂—CH₂—CH₂—OH, —CH₂—CH(OH)—CH₃, —CH(OH)—CH₂—CH₃, and —(CH₂CH₂—O)ₙH and x denotes an integer between 1 and 6.

Polymers which are very particularly preferred for the purposes of the present application are those which comprise a cationic monomer unit of the above general formula, in which R¹ denotes H and R², R³, R⁴ and R⁵ denote methyl and x denotes 3. The corresponding monomer units of the formula

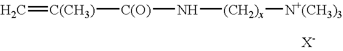

are also known as MAPTAC (methyacrylamidopropyltrimethylammonium chloride) when X⁻ is chloride.

Polymers which contain diallyldimethylammonium salts and/or acrylamidopropyltrimethylammonium salts as monomer units are preferably used according to the invention.

The previously mentioned amphoteric polymers comprise not only cationic groups, but also anionic groups or monomer units. Such anionic monomer units originate for example from the group of linear or branched, saturated or unsaturated carboxylates, linear or branched, saturated or unsaturated phosphonates, linear or branched, saturated or unsaturated sulfates or linear or branched, saturated or unsaturated sulfonates. Preferred monomer units are acrylic acid, (meth)acrylic acid, (dimethyl)acrylic acid, (ethyl)acrylic acid, cyanoacrylic acid, vinylacetic acid, allylacetic acid, crotonic acid, maleic acid, fumaric acid, cinnamic acid and the derivatives thereof, allylsulfonic acids, such as for example allyloxybenzenesulfonic acid and methallylsulfonic acid or allylphosphonic acids.

Preferably usable amphoteric polymers originate from the group of alkylacrylamide/acrylic acid copolymers, alkylacrylamide/methacrylic acid copolymers, alkylacrylamide/methyl methacrylic acid copolymers, alkylacrylamide/acrylic acid/alkylaminoalkyl(meth)acrylic acid copolymers, alkylacrylamide/methacrylic acid/alkylaminoalkyl(meth)acrylic acid copolymers, alkylacrylamide/methyl methacrylic acid/alkylaminoalkyl(meth)acrylic acid copolymers, alkylacrylamide/alkyl methacrylate/alkylaminoethyl methacrylate/alkyl methacrylate copolymers and copolymers of unsaturated carboxylic acids, cationically derivatized unsaturated carboxylic acids and optionally further ionic or nonionogenic monomers.

Preferably usable zwitterionic polymers originate from the group of acrylamidoalkyltrialkylammonium chloride/acrylic acid copolymers and the alkali metal and ammonium salts thereof, acrylamidoalkyltrialkylammonium chloride/methacrylic acid copolymers and the alkali metal and ammonium salts thereof and methacroylethylbetaine/methacrylate copolymers.

Amphoteric polymers which, in addition to one or more anionic monomers, comprise methacrylamidoalkyltrialkylammonium chloride and dimethyl(diallyl)ammonium chloride as cationic monomers are furthermore preferred.

Particularly preferred amphoteric polymers originate from the group of methacrylamidoalkyltrialkylammonium chloride/dimethyl(diallyl)ammonium chloride/acrylic acid copolymers, methacrylamidoalkyltrialkylammonium chloride/dimethyl(diallyl)ammonium chloride/methacrylic acid copolymers and methacrylamidoalkyltrialkylammonium chloride/dimethyl(diallyl)ammonium chloride/alkyl(meth)acrylic acid copolymers and the alkali metal and ammonium salts thereof.

Particularly preferred amphoteric polymers are those from the group of methacrylamidopropyltrimethylammonium chloride/dimethyl(diallyl)ammonium chloride/acrylic acid copolymers, methacrylamidopropyltrimethylammonium chloride/dimethyl(diallyl)ammonium chloride/acrylic acid copolymers and methacrylamidopropyltrimethylammonium chloride/dimethyl(diallyl)ammonium chloride/alkyl(meth)acrylic acid copolymers and the alkali metal and ammonium salts thereof.

In one particularly preferred embodiment of the present invention, the polymers assume preformulated form. The polymers may here suitably be formulated inter alia by
encapsulating the polymers by means of water-soluble or water-dispersible coating compositions, preferably by means of water-soluble or water-dispersible natural or synthetic polymers;
encapsulating the polymers by means of water-insoluble, fusible coating compositions, preferably by means of water-insoluble coating compositions from the group of waxes or paraffins with a melting point above 30° C.;
cogranulating the polymers with inert carrier materials, preferably with carrier materials from the group of substances with a washing or cleaning action, particularly preferably from the group of builders or cobuilders.

Washing or cleaning agents preferably contain the above-stated cationic and/or amphoteric polymers in quantities of between 0.01 and 10 wt. %, in each case relative to the total weight of the washing or cleaning agent. Washing or cleaning agents which are preferred for the purposes of the present application are, however, those in which the proportion by weight of the cationic and/or amphoteric polymers amounts to between 0.01 and 8 wt. %, preferably between 0.01 and 6 wt. %, preferably between 0.01 and 4 wt. %, particularly preferably between 0.01 and 2 wt. % and in particular between 0.01 and 1 wt. %, in each case relative to the total weight of the automatic dishwashing agent.

Enzymes may be used to increase the washing or cleaning performance of washing or cleaning agents. These include in particular proteases, amylases, lipases, hemicellulases, cellulases, perhydrolases or oxidoreductases, and preferably mixtures thereof. These enzymes are in principle of natural origin; starting from the natural molecules, improved variants are available for use in washing or cleaning agents, said variants accordingly preferably being used. Washing or cleaning agents preferably contain enzymes in total quantities of 1×10⁻⁶ to 5 wt. % relative to active protein. Protein concentration may be determined with the assistance of known methods, for example the BCA method or the biuret method.

Among proteases, those of the subtilisin type are preferred. Examples of these are subtilisins BPN′ and Carlsberg and their further developed forms protease PB92, subtilisins 147 and 309, alkaline protease from Bacillus lentus, subtilisin DY and the enzymes thermitase, proteinase K and proteases TW3 and TW7, which are classed among subtilases but no longer among the subtilisins as more narrowly defined.

Examples of amylases usable according to the invention are the α-amylases from Bacillus licheniformis, from B. amyloliquefaciens, from B. stearothermophilus, from Aspergillus niger and A. oryzae and the further developed forms of the above-stated amylases which have been improved for use in washing and cleaning agents. Particular note should furthermore be taken for this purpose of the α-amylase from Bacillus sp. A 7-7 (DSM 12368) and the cyclodextrin glucanotransferase (CGTase) from B. agaradherens (DSM 9948).

Lipases or cutinases, in particular because of their triglyceride-cleaving activities, but also in order to produce peracids in situ from suitable precursors may furthermore be used according to the invention. These include, for example, lipases originally obtainable or further developed from Humicola lanuginosa (Thermomyces lanuginosus), in particular those with the D96L amino acid substitution. Furthermore, the cutinases which were originally isolated from Fusarium solani pisi and Humicola insolens are, for example, also usable. Lipases or cutinases, the initial enzymes of which were originally isolated from Pseudomonas mendocina and Fusarium solanii, may furthermore be used.

Enzymes which fall within the class of hemicellulases may furthermore be used. These include, for example, mannanases, xanthan lyases, pectin lyases (=pectinases), pectin esterases, pectate lyases, xyloglucanases (=xylanases), pullulanases and β-glucanases.

Automatic dishwashing agents preferred according to the invention are characterized in that they contain enzyme granules with an enzyme content of below 5 wt. %, preferably below 4 wt. % of enzyme active substance.

Oxidoreductases, for example oxidases, oxygenases, catalases, peroxidases, such as halo-, chloro-, bromo-, lignin, glucose or manganese peroxidases, dioxygenases or laccases (phenol oxidases, polyphenol oxidases) may be used according to the invention to increase bleaching action. Compounds, preferably organic compounds, particularly preferably aromatic compounds, which interact with the enzymes are advantageously also added in order to enhance the activity of the oxidoreductases in question (enhancers) or, in the event of a major difference in redox potential between the oxidizing enzymes and the soiling, to ensure electron flow (mediators).

The enzymes may be used in any form established in the prior art. This includes, for example, solid preparations obtained by granulation, extrusion or freeze-drying or, in particular in the case of preparations in liquid or gel form, solutions of the enzymes, advantageously as concentrated as possible, with a low water content and/or combined with stabilizers.

Alternatively, both for the solid and the liquid presentation, the enzymes may be encapsulated, for example by spray drying or extruding the enzyme solution together with a preferably natural polymer or in the form of capsules, for example those in which the enzymes are enclosed for instance in a solidified gel or those of the core-shell type, in which an enzyme-containing core is coated with a protective layer which is impermeable to water, air and/or chemicals. Further active ingredients, for example stabilizers, emulsifiers, pigments, bleaching agents or dyes may additionally be applied in superimposed layers. Such capsules are applied in accordance with per se known methods, for example by agitated or rolling granulation or in fluidized bed processes. Advantageously, such granules are low-dusting, for example due to the application of a polymeric film former, and stable in storage thanks to the coating.

It is furthermore possible to formulate two or more enzymes together such that a single granular product comprises two or more enzyme activities.

A protein and/or enzyme may be protected, particularly during storage, from damage such as for example inactivation, denaturation or degradation for instance due to physical influences, oxidation or proteolytic cleavage. If the proteins and/or enzymes are isolated from microbes, inhibition of proteolysis is particularly preferred, in particular if the preparations also contain proteases. Washing or cleaning agents may contain stabilizers for this purpose; the provision of such preparations constitutes a preferred embodiment of the present invention.

One or more enzymes and/or enzyme preparations, preferably solid protease preparations and/or amylase preparations, are preferably used in quantities of 0.1 to 6 wt. %, preferably of 0.2 to 5 wt. % and in particular of 0.4 to 5 wt. %, in each case relative to the total enzyme-containing preparations.

The following tables show some example formulations of such preferred phosphate-free automatic dishwashing agents:

| | Formu- | Formu- | Formu- | Formu- |
|---|---|---|---|---|
| | lation 21 | lation 22 | lation 23 | lation 24 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Enzyme | 0.1 to 6 | 0.2 to 5 | 0.4 to 5 | 0.4 to 5 |
| Misc | Ad 100 | Ad 100 | Ad 100 | Ad 100 |

¹Copolymer comprising
i) monomers from the group of mono- or polyunsaturated carboxylic acids
ii) monomers from the group of mono- or polyunsaturated hydrocarbon residues with 2 to 26 carbon atoms

| | Formu- | Formu- | Formu- | Formu- |
|---|---|---|---|---|
| | lation 25 | lation 26 | lation 27 | lation 28 |
| Ingredient | [wt. %] | [wt. %] | [wt. %] | [wt. %] |
| Citrate | 5 to 60 | 10 to 55 | 15 to 50 | 15 to 50 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Enzyme | 0.1 to 6 | 0.2 to 5 | 0.4 to 5 | 0.4 to 5 |
| Misc | Ad 100 | Ad 100 | Ad 100 | Ad 100 |

¹Copolymer comprising
i) monomers from the group of mono- or polyunsaturated sulfonic acids
ii) monomers from the group of mono- or polyunsaturated hydrocarbon residues with 2 to 26 carbon atoms

The present application particularly preferably provides a automatic dishwashing agent which contains
a) 10 to 55 wt. % of citrate
b) 0.01 to 2 wt. % of bleach catalyst selected from the group of bleach-boosting transition metal salts and transition metal complexes
c) 0.5 to 25 wt. % of copolymer(s), comprising

i) monomer(s) containing acid groups

ii) further hydrophobic monomer(s)
d) 2 to 15 wt. % of sodium percarbonate
e) 2 to 8 wt. % of nonionic surfactant(s)
f) 1.0 to 6 wt. % of enzyme.

Glass corrosion inhibitors prevent the occurrence not only of hazing, streaking and scratching but also of iridescence on the surface of machine cleaned glasses. Preferred glass corrosion inhibitors originate from the group of magnesium and zinc salts and of magnesium and zinc complexes.

The spectrum of zinc salts preferred according to the invention, preferably of organic acids, particularly preferably of organic carboxylic acids, extends from salts which are sparingly soluble or insoluble in water, i.e. exhibit a solubility of below 100 mg/l, preferably of below 10 mg/l, in particular of below 0.01 mg/l, up to those salts which exhibit a solubility in water of above 100 mg/l, preferably of above 500 mg/l, particularly preferably of above 1 g/l and in particular of above 5 g/l (all solubilities at 20° C. water temperature). The first group of zinc salts includes for example zinc citrate, zinc oleate and zinc stearate, while the group of soluble zinc salts includes for example zinc formate, zinc acetate, zinc lactate and zinc gluconate.

At least one zinc salt of an organic carboxylic acid, particularly preferably a zinc salt from the group of zinc stearate, zinc oleate, zinc gluconate, zinc acetate, zinc lactate and zinc citrate is particularly preferentially used as a glass corrosion inhibitor. Zinc ricinoleate, zinc abietate and zinc oxalate are also preferred.

For the purposes of the present invention, the content of zinc salt in washing or cleaning agents preferably amounts to between 0.1 and 5 wt. %, preferably between 0.2 and 4 wt. % and in particular between 0.4 and 3 wt. %, or the content of zinc in oxidized form (calculated as Zn²⁺) amounts to between 0.01 and 1 wt. %, preferably between 0.02 and 0.5 wt. % and in particular between 0.04 and 0.5 wt. %, in each case relative to the total weight of the preparation containing the glass corrosion inhibitor.

Corrosion inhibitors serve to protect the items being washed or the machine, silver protection agents being of particular significance in relation to automatic dishwashing. Known prior art substances may be used. In general, silver protection agents which may be used are those primarily selected from the group of triazoles, benzotriazoles, bisbenzotriazoles, aminotriazoles, alkylaminotriazoles and transition metal salts or complexes. Benzotriazole and/or alkylaminotriazole are particularly preferably used. 3-Amino-5-alkyl-1,2,4-triazoles or the physiologically acceptable salts thereof are preferably used according to the invention, these substances particularly preferentially being used in a concentration of 0.001 to 10 wt. %, preferably of 0.0025 to 2 wt. %, particularly preferably of 0.01 to 0.04 wt. %.

Perfume oils or fragrances which may be used for the purposes of the present invention are individual odoriferous compounds, for example synthetic products of the ester, ether, aldehyde, ketone, alcohol and hydrocarbon type. Preferably, however, mixtures of various odoriferous substances are used which together produce an attractive fragrance note. Such perfume oils may also contain natural odoriferous mixtures, as are obtainable from plant sources, for example pine, citrus, jasmine, patchouli, rose or ylang-ylang oil.

The fragrances may be directly processed, but it may also be advantageous to apply the fragrances onto carriers which ensure a long-lasting fragrance thanks to slower fragrance release. Cyclodextrins have, for example, proved to be effective such carrier materials, it being possible additionally to coat the cyclodextrin-perfume complexes with further auxiliary substances.

Preferred dyes, the selection of which will cause the person skilled in the art no difficulty, have elevated storage stability and are insensitive to the other ingredients of the preparations and to light and have no marked substantivity relative to the substrates such as for example textiles, glass, ceramics or plastic crockery to be treated with the dye-containing preparations so as not to dye these substrates.

The following tables show some example formulations of such preferred phosphate-free automatic dishwashing agents:

| | Formulation | Formulation | Formulation | Formulation |
|---|---|---|---|---|
| Ingredient | 29 [wt. %] | 30 [wt. %] | 31 [wt. %] | 32 [wt. %] |
| Citrate | 5 to 60 | 10 to 55 | 15 to 50 | 15 to 50 |
| Carbonate/ | 2 to 40 | 2 to 40 | 2 to 40 | 2 to 40 |
| hydrogen- | | | | |
| carbonate | | | | |
| Silicate | 0 to 15 | 0 to 15 | 0 to 15 | 0.1 to 10 |
| Phosphonate | 0 to 14 | 0 to 14 | 0 to 14 | 2 to 8 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Enzyme | 0.1 to 6 | 0.2 to 5 | 0.4 to 5 | 0.4 to 5 |
| Misc | Ad 100 | Ad 100 | Ad 100 | Ad 100 |

¹Copolymer comprising
i) monomers from the group of mono- or polyunsaturated carboxylic acids
ii) monomers from the group of mono- or polyunsaturated hydrocarbon residues with 2 to 26 carbon atoms

| | Formulation | Formulation | Formulation | Formulation |
|---|---|---|---|---|
| Ingredient | 33 [wt. %] | 34 [wt. %] | 35 [wt. %] | 36 [wt. %] |
| Citrate | 5 to 60 | 10 to 55 | 15 to 50 | 15 to 50 |
| Carbonate/ | 2 to 40 | 2 to 40 | 2 to 40 | 2 to 40 |
| hydrogen- | | | | |
| carbonate | | | | |
| Silicate | 0 to 15 | 0 to 15 | 0 to 15 | 0.1 to 10 |
| Phosphonate | 0 to 14 | 0 to 14 | 0 to 14 | 2 to 8 |
| Bleaching | 1 to 20 | 2 to 15 | 4 to 10 | 4 to 10 |
| agent | | | | |
| Bleach catalyst | 0.01 to 3 | 0.02 to 2 | 0.02 to 2 | 0.02 to 1 |
| Copolymer¹ | 0.1 to 30 | 0.5 to 25 | 1.0 to 20 | 1.0 to 20 |
| Nonionic | 1 to 10 | 2 to 8 | 2 to 8 | 3 to 6 |
| surfactant | | | | |
| Enzyme | 0.1 to 6 | 0.2 to 5 | 0.4 to 5 | 0.4 to 5 |
| Misc | Ad 100 | Ad 100 | Ad 100 | Ad 100 |

¹Copolymer comprising
i) monomers from the group of mono- or polyunsaturated sulfonic acids
ii) monomers from the group of mono- or polyunsaturated hydrocarbon residues with 2 to 26 carbon atoms

The automatic dishwashing agent according to the invention may be formulated in solid or liquid form, but may, for example, also assume the form of a combination of solid and liquid presentations.

Suitable solid presentations are in particular powders, granules, extrudates or compacted products, in particular tablets. The liquid presentations based on water and/or organic solvents may be thickened, assuming gel form.

Preparations according to the invention may be formulated as monophasic or multiphasic products. Preferred automatic dishwashing agents are in particular those with one, two, three or four phases. Automatic dishwashing agents which are characterized in that they assume the form of a prefabricated dispensing unit with two or more phases are particularly preferred.

The individual phases of multiphasic preparations may be of identical or different states of aggregation. Preferred automatic dishwashing agents are in particular those which comprise at least two different solid phases and/or at least two liquid phases and/or at least one solid and at least one liquid phase.

Automatic dishwashing agents according to the invention are preferably preformulated as dispensing units. These dispensing units preferably comprise the quantity of substances with a washing or cleaning action required for a washing operation. Preferred dispensing units have a weight of between 12 and 30 g, preferably of between 14 and 26 g and in particular of between 15 and 22 g.

The volume of the above-stated dispensing units and their three-dimensional shape are particularly preferentially selected such that the preformulated units can be dispensed by means of the dispensing chamber of a dishwashing machine. The volume of the dispensing unit therefore preferably amounts to between 10 and 35 ml, preferably between 12 and 30 ml and in particular between 15 and 25 ml.

The automatic dishwashing agents according to the invention, in particular the prefabricated dispensing units, particularly preferentially comprise a water-soluble covering.

Disintegration of prefabricated moldings may be facilitated by incorporating disintegration auxiliaries or “tablet disintegrants” into these preparations in order to shorten disintegration times.

These substances, known as disintegrants due to their mode of action, increase in volume on exposure to water, resulting, on the one hand, in an increase of their own volume (swelling) and, on the other hand, possibly also in generation of pressure due to the release of gases, causing the tablet to break up into smaller particles. Disintegration auxiliaries which have long been known are for example carbonate/citric acid systems, it also being possible to use other organic acids. Swelling disintegration auxiliaries are for example synthetic polymers such as polyvinylpyrrolidone (PVP) or natural polymers or modified natural materials such as cellulose and starch and the derivatives thereof, alginates or casein derivatives.

Disintegration auxiliaries are preferably used in quantities of 0.5 to 10 wt. %, preferably of 3 to 7 wt. % and in particular of 4 to 6 wt. %, in each case relative to the total weight of the preparation containing the disintegration auxiliary.

Preferably used disintegration agents are those based on cellulose, such that preferred washing or cleaning agents contain such a cellulose-based disintegration agent in quantities of 0.5 to 10 wt. %, preferably of 3 to 7 wt. % and in particular of 4 to 6 wt. %. The cellulose used as a disintegration auxiliary is preferably not used in finely divided form, but is instead converted into a coarser form, for example is granulated or compacted, before being mixed into the premixes which are to be pressed. The particle sizes of such disintegration agents are for the most part above 200 μm, at least 90 wt. % preferably being between 300 and 1600 μm and in particular at least 90 wt. % being between 400 and 1200 μm.

Preferred disintegration auxiliaries, preferably a cellulose-based disintegration auxiliary, preferably in granular, cogranulated or compacted form, are present in the preparation containing the disintegration agent in quantities of 0.5 to 10 wt. %, preferably of 3 to 7 wt. % and in particular of 4 to 6 wt. %, in each case relative to the total weight of the preparation containing the disintegration agent.

Gas-evolving effervescent systems may furthermore preferably be used according to the invention as tablet disintegration auxiliaries. The gas-evolving effervescent system may consist of a single substance which releases a gas on contact with water. Magnesium peroxide, which releases oxygen on contact with water, may in particular be mentioned among these compounds. Preferred effervescent systems, however, consist of at least two components which react together with formation of gas, for example of alkali metal carbonate and/or hydrogencarbonate and an acidifying agent which is suitable for releasing carbon dioxide from the alkali metal salts in aqueous solution. Usable acidifying agents which release carbon dioxide from the alkali metal salts in aqueous solution are, for example, boric acid and alkali metal hydrogensulfates, alkali metal dihydrogenphosphates and other inorganic salts. Organic acidifying agents are, however, preferably used, citric acid being a particularly preferred acidifying agent. Preferred acidifying agents in the effervescent system are from the group of organic di-, tri- and oligocarboxylic acids or mixtures.

The present application furthermore provides a method for washing dishes in a dishwashing machine using automatic dishwashing agents according to the invention, the automatic dishwashing agents preferably being dispensed into the interior of a dishwashing machine during the performance of a dishwashing program, before the start of the main washing cycle or in the course of the main washing cycle. Dispensing or introduction of the preparation according to the invention into the interior of the dishwashing machine may proceed manually, but the preparation is preferably dispensed into the interior of the dishwashing machine by means of the dispensing chamber of the dishwashing machine. Preferably, no additional water softener and no additional rinse aid is dispensed into the interior of the dishwashing machine in the course of the washing method.

This application further provides a kit for a dishwashing machine, comprising
a) a automatic dishwashing agent according to the invention;
b) instructions, which instruct the consumer to use the automatic dishwashing agent without the addition of a rinse aid and/or a softening salt.

While particular embodiments of the present invention have been illustrated and described, it would be obvious to those skilled in the art that various other changes and modifications can be made without departing from the spirit and scope of the invention.

Other than where otherwise indicated, or where required to distinguish over the prior art, all numbers expressing quantities of ingredients herein are to be understood as modified in all instances by the term “about”. As used herein, the words “may” and “may be” are to be interpreted in an open-ended, non-restrictive manner. At minimum, “may” and “may be” are to be interpreted as definitively including, but not limited to, the composition, structure, or act recited.

As used herein, and in particular as used herein to define the elements of the claims that follow, the articles “a” and “an” are synonymous and used interchangeably with “at least one” or “one or more,” disclosing or encompassing both the singular and the plural, unless specifically defined herein otherwise. The conjunction “or” is used herein in both in the conjunctive and disjunctive sense, such that phrases or terms conjoined by “or” disclose or encompass each phrase or term alone as well as any combination so conjoined, unless specifically defined herein otherwise.

The description of a group or class of materials as suitable or preferred for a given purpose in connection with the invention implies that mixtures of any two or more of the members of the group or class are equally suitable or preferred. Description of constituents in chemical terms refers unless otherwise indicated, to the constituents at the time of addition to any combination specified in the description, and does not necessarily preclude chemical interactions among the constituents of a mixture once mixed. Steps in any method disclosed or claimed need not be performed in the order recited, except as otherwise specifically disclosed or claimed.

Changes in form and substitution of equivalents are contemplated as circumstances may suggest or render expedient. Although specific terms have been employed herein, such terms are intended in a descriptive sense and not for purposes of limitation.

The following Examples further illustrate the preferred embodiments within the scope of the present invention, but are not intended to be limiting thereof. It is understood that the examples and embodiments described herein are for illustrative purposes only and that various modifications or changes in light thereof will be suggested to one skilled in the art without departing from the scope of the present invention. The appended claims therefore are intended to cover all such changes and modifications that are within the scope of this invention.

### EXAMPLES

In an automatic dishwashing method, soiled dishes were washed in a dishwashing machine (Miele G 698) with 21 g of the automatic dishwashing agent comparisons 1 and 2 and invention 1 at a water hardness of 21 German hardness degrees and a temperature of 50° C.

The following table shows the composition of the dishwashing agents used:

| Raw material | Comparison 1 | Comparison 2 | Invention 1 |
|---|---|---|---|
| Citrate | 43.0 | 33.0 | 33.0 |
| Silicate | 2.0 | 2.0 | 2.0 |
| Phosphonate | 2.0 | 2.0 | 2.0 |
| Soda | 28.0 | 28.0 | 28.0 |
| Sodium percarbonate | 10.0 | 10.0 | 10.0 |
| Bleach catalyst | 0.03 | 0.03 | 0.03 |
| Protease | 3.5 | 3.5 | 3.5 |
| Amylase | 0.5 | 0.5 | 0.5 |
| Nonionic surfactant | 5.0 | 5.0 | 5.0 |
| Copolymer¹ | — | 10 | — |
| Copolymer² | — | — | 10.0 |
| Misc | Ad 100 | Ad 100 | Ad 100 |

¹Acrylic acid homopolymer
²Hydrophobically modified copolymer

The overall appearance of the washed dishes was assessed against the evaluation scale shown below. The results are stated in the following table (the stated values are averages from 3 tests):

| Cleaning | | | |
|---|---|---|---|
| performance | Comparison 1 | Comparison 2 | Invention 1 |
| Tea | 8.0 | 7.5 | 9.0 |
| Milk | 8.5 | 8.0 | 8.5 |
| Minced meat | 10.0 | 10.0 | 10.0 |
| Starch | 7.5 | 7.0 | 7.5 |

Evaluation scale for washing: 10 = no dirt to 0 = severe dirt

What is claimed:

1. A phosphate-free cleaning agent comprising a bleaching agent and:
a) a citrate
b) a bleach catalyst comprising a bleach-boosting transition metal salts or a transition metal complex; and
c) a copolymer comprising:
i) a monomer comprising an acid group; and
ii) a hydrophobic monomer.

2. The cleaning agent of claim 1, comprising 5% to 60% by weight of the citrate.

3. The cleaning agent of claim 2, comprising 10% to 55% by weight of the citrate.

4. The cleaning agent of claim 3, comprising 15% to 50% by weight of the citrate.

5. The cleaning agent of claim 1, comprising 0.01% to 3.0% by weight of the bleach catalyst b).

6. The cleaning agent of claim 5, comprising 0.02% to 2.0% by weight of the bleach catalyst b).

7. The cleaning agent of claim 6, comprising 0.02% to 1.0% by weight of the bleach catalyst b).

8. The cleaning agent of claim 1, wherein the bleach catalyst comprises a complex of manganese with 1,4,7-trimethyl-1,4,7-triazacyclononane (Me₃-TACN) or 1,2,4,7-tetramethyl-1,4,7-triazacyclononane (Me₄-TACN).

9. The cleaning agent of claim 1, comprising 1.0% to 20% by weight of the bleaching agent, the bleaching agent comprising an oxygen bleaching agent.

10. The cleaning agent of claim 9, comprising 4.0% to 18% by weight of the bleaching agent.

11. The cleaning agent of claim 10, comprising 8% to 15% by weight of the bleaching agent.

12. The cleaning agent of claim 9, wherein the oxygen bleaching agent comprises sodium percarbonate.

13. The washing or cleaning agent of claim 1, comprising 0.1% to 30% by weight of the copolymer c), said copolymer c) comprising:
i) a monomer comprising a carboxylic acid group; and
ii) a monomer comprising a sulfonic acid group.

14. The washing or cleaning agent of claim 13, comprising 0.5% to 25% by weight of the copolymer c).

15. The washing or cleaning agent of claim 14, comprising 1.0% to 20% by weight of the copolymer c).

16. The washing or cleaning agent of claim 1, comprising 0.1% to 30% by weight of the copolymer c), said copolymer c) comprising:
i) a monomer comprising an acid group; and
ii) a hydrophobic monomer.

17. The washing or cleaning agent of claim 16, comprising 0.5% to 25% by weight of the copolymer c).

18. The washing or cleaning agent of claim 17, comprising 1.0% to 20% by weight of the copolymer c).

19. The cleaning agent of claim 1, wherein the copolymer c) comprises:
i) a mono- or polyunsaturated carboxylic acid monomer; and
ii) a monomer comprising a mono- or polyunsaturated hydrocarbon residue having 2 to 26 carbon atoms.

20. The cleaning agent of claim 1, wherein the copolymer c) comprises:
i) a mono- or polyunsaturated sulfonic acid monomer; and
ii) a monomer comprising a mono- or polyunsaturated hydrocarbon residue having 2 to 26 carbon atoms.

21. The cleaning agent of claim 1, comprising 1% to 10% by weight of a nonionic surfactant.

22. The cleaning agent of claim 21, comprising 2% to 8% by weight of the nonionic surfactant.

23. The cleaning agent of claim 22, comprising 3% to 6% by weight of the nonionic surfactant.

24. The cleaning agent of claim 1, comprising:
a) 10% to 55% by weight of the citrate;
b) 0.02% to 2% by weight of the bleach catalyst:
c) 0.5% to 25% by weight of the copolymer c) comprising:
i) a monomer comprising an acid group; and
ii) a hydrophobic monomer;
d) 2% to 15% by weight of sodium percarbonate;
e) 2% to 8% by weight of a nonionic surfactant; and
f) 1.0% to 6% by weight of an enzyme.

25. The cleaning agent of claim 1, comprising no carboxymethyl inulin.

26. The cleaning agent of claim 1, comprising an enzyme granule, said granule comprising less than 5% by weight of enzyme active substance.

27. The cleaning agent of claim 26, wherein the enzyme granule comprises less than 4% by weight of enzyme active substance.

28. A method for washing dishes in a dishwashing machine, comprising contacting a dish in need of washing with an effective amount of the cleaning agent of claim 1 in a wash cycle of a dishwashing machine.

29. The method of claim 28, wherein no additional water softener and no additional rinse aid is dispensed into the interior of the dishwashing machine in the course of the washing method.
